(19) United States
(12) Patent Application Publication
(10) Pub. No.: US 2012/0013945 A1
(43) Pub. Date: Jan. 19, 2012

(54) IMAGE FORMING APPARATUS AND DATA NOTIFICATION AND PRINTING METHOD BY IMAGE FORMING APPARATUS

(75) Inventor: Akitoshi SUZUKI, Shizuoka (JP)

(73) Assignees: Toshiba Tec Kabushiki Kaisha, Tokyo (JP); Kabushiki Kaisha Toshiba, Tokyo (JP)

(21) Appl. No.: 13/164,751

(22) Filed: Jun. 20, 2011

Related U.S. Application Data
(60) Provisional application No. 61/363,989, filed on Jul. 13, 2010.

(51) Int. Cl. G06K 15/02

(52) U.S. Cl. 358/1.15

(57) ABSTRACT

According to one embodiment, an image forming apparatus includes: a fax receiving unit capable of receiving facsimile data; a printing unit which prints the facsimile data received by the fax receiving unit; a fax data storage unit in which, if the facsimile data received by the fax receiving unit is secure fax data, this secure fax data is stored; and an addition detecting unit which detects that a removable network addition device is connected to the apparatus.

### CROSS-REFERENCE TO RELATED APPLICATION

This application is based upon and claims the benefit of priority from Provisional U.S. Application 61/363,989 filed on Jul. 13, 2010, the entire contents of which are incorporated herein by reference.

### FIELD

Embodiments described herein relate generally to an image forming apparatus and a data notification and printing method by the image forming apparatus.

### BACKGROUND

A facsimile receiver is configured to print and output facsimile information that is received. However, if facsimile information of a confidential content is directly printed and outputted, there is a risk of other people seeing that information. Thus, storing confidential facsimile information without printing is known.

A technique is known of receiving facsimile information, and if the facsimile information is recognized as confidentially received, storing the confidentially received facsimile information in a reception box corresponding to a client and then notifying the client via a local area network (LAN).

According to an exemplary embodiment, secure fax data is stored in an image forming apparatus connected with a removable network addition device and a client terminal at a destination is notified via a network.

### BRIEF DESCRIPTION OF THE DRAWINGS

FIG. 1 shows an exemplary overall configuration of a system according to an embodiment.

FIG. 2 shows an exemplary configuration of an MFP and a network addition device according to the embodiment.

FIG. 3 is a flowchart for explaining operation of the MFP and the network addition device according to the embodiment.

FIG. 4 illustrates state transition of the MFP with the network addition device connected therewith in the embodiment.

FIG. 5 illustrates state transition of the MFP with the network addition device not connected therewith in the embodiment.

FIG. 6 is a flowchart for explaining operation where an instruction to print secure fax data is given from a client PC terminal to the MFP in the embodiment.

FIG. 7A shows the former half of an example of fax data received by the MFP in the embodiment.

FIG. 7B shows the latter half of the example of fax data received by the MFP in the embodiment.

FIG. 8 shows an example of a notification e-mail displayed on a screen of the client PC terminal in the embodiment.

FIG. 9 shows an example of a screen where an instruction to print secure fax data is given from the client PC terminal to the MFP in the embodiment.

FIG. 10 is a flowchart for explaining operation where an instruction to print secure fax data is given from a control panel of the MFP in the embodiment.

FIG. 11 shows an exemplary configuration of the control panel of the MFP in the embodiment.

FIG. 12 shows an exemplary display screen on a touch panel display located on the control panel for selecting secure fax data in the embodiment.

### DETAILED DESCRIPTION

In general, according to one embodiment, an image forming apparatus includes: a fax receiving unit capable of receiving facsimile data; a printing unit which prints the facsimile data received by the fax receiving unit; a fax data storage unit in which, if the facsimile data received by the fax receiving unit is secure fax data, this secure fax data is stored; and an addition detecting unit which detects that a removable network addition device is connected to the apparatus.

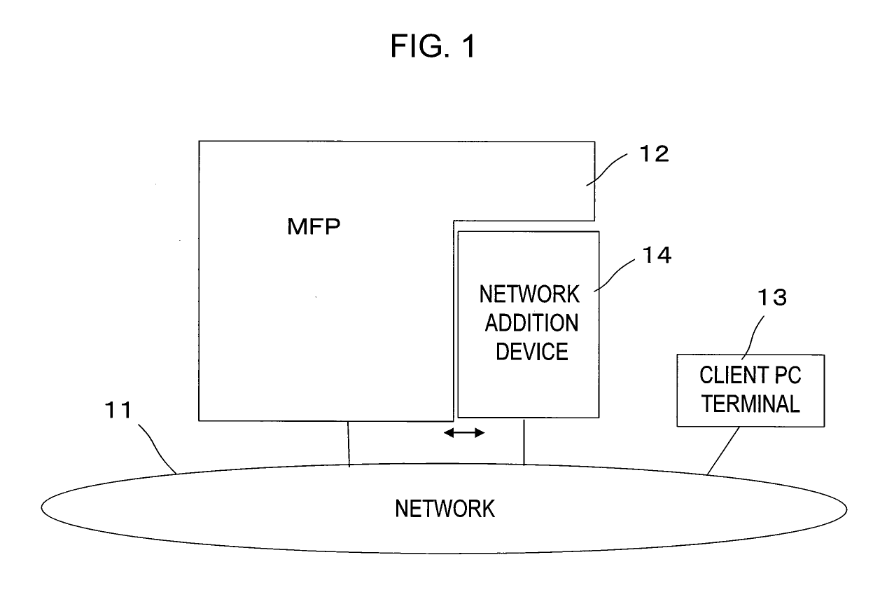

Hereinafter, embodiments will be described with reference to the drawings. An exemplary configuration according to an embodiment is shown in FIG. 1. An image forming apparatus (MFP) 12 capable of at least transmitting and receiving facsimile signals, and a client PC terminal 13 and the like can be connected to a network 11 such as the internet. In FIG. 1, one MFP 12 and one client terminal 13 are connected. However, two or more of each may be connected. An optional network addition device 14 can be attached to or detached from the MFP 12. When the network addition device 14 is loaded on the MFP 12, the MFP 12 is connected to the network 11.

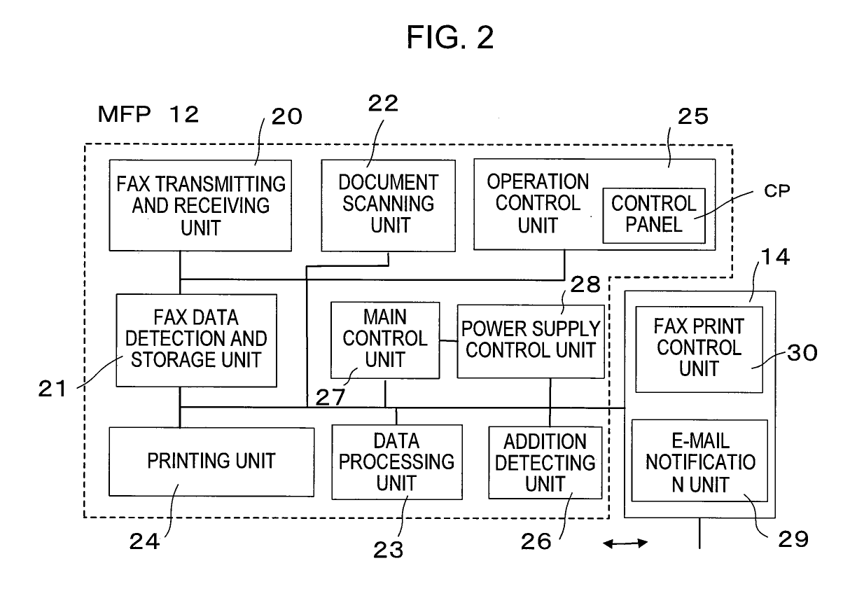

An exemplary configuration of the MFP 12 and the network addition device 14 is shown in FIG. 2. This MFP 12 has a fax transmitting and receiving unit 20 which transmits and receives facsimile data, a fax data detection and storage unit 21 which detects facsimile data is secure if secured facsimile data (secure fax data) is received and in which the fax data is temporarily stored if the fax data is secure fax data, a document scanning unit 22 which scans a document to acquire data for copying or the like and thus acquires a latent image, a data processing unit 23 which processes fax-transmitted or received data, copy data and the like, a printing unit 24 which develops fax-received data or a latent image and prints copy data, an operation control unit 25 to which a user gives an instruction for operation from a control panel CP, an addition detecting unit 26 which detects that the network addition device 14 is connected to this MFP, a main control unit 27 which controls each of these units, and a power supply control unit 28 which controls power supply to each unit.

The document scanning unit 22, for example, scans a document and acquires reflected light, then casts the reflected light onto a photoconductive unit such as a photoconductive drum that is uniformly charged, so as to selectively expose the photoconductive unit to the light, and thus acquires an electrostatic latent image. The printing unit 24 attaches, for example, powder toner to the electrostatic latent image so as to visualize the latent image, and transfers the image to a sheet and then fixes the image by heating. Here, such process including the visualization, transfer and fixing of the electrostatic latent image is referred to as printing. The printing unit 24 also handles visualization of fax data received by the fax transmitting and receiving unit 20 as printing.

The network addition device 14 has an e-mail notification unit 29 which sends an e-mail telling that secure fax data is received, to the client PC terminal 13 via the network 11 if the secure fax data is received by the fax transmitting and receiving unit 20 of the MFP 12, a fax print control unit 30 which gives the MFP 12 an instruction for printing of a secure reception from the client PC terminal 13. The network addition device 14 has a web page called TopAccess within the fax print control unit 30.

As the network addition device 14 receives a notification of a reception of secure fax data from the fax data detection and storage unit 21, a proper link based on the date and fax job ID is created for the data and an e-mail including this link is transmitted to the client PC terminal 13 of the destination. By opening the received e-mail and clicking on the link at the client PC terminal, the user can access the secure fax data.

From the control panel CP, an instruction to print the copy data acquired by scanning by the document scanning unit 22, or an instruction to print the secure fax data that is securely received and stored in the fax data detection and storage unit 21, can be given to the printing unit 24. The instruction to print the secure fax data stored in the fax data detection and storage unit 21 can also be given from the client PC terminal 13 connected to the network 11.

The power supply control unit 28 controls power supply to each unit of the MFP 12, thus shifting the apparatus from one normal operation state (ready state) R1 to an energy-saving sleep state (first sleep state) S1 and then to a super-sleep state (second sleep state) S2.

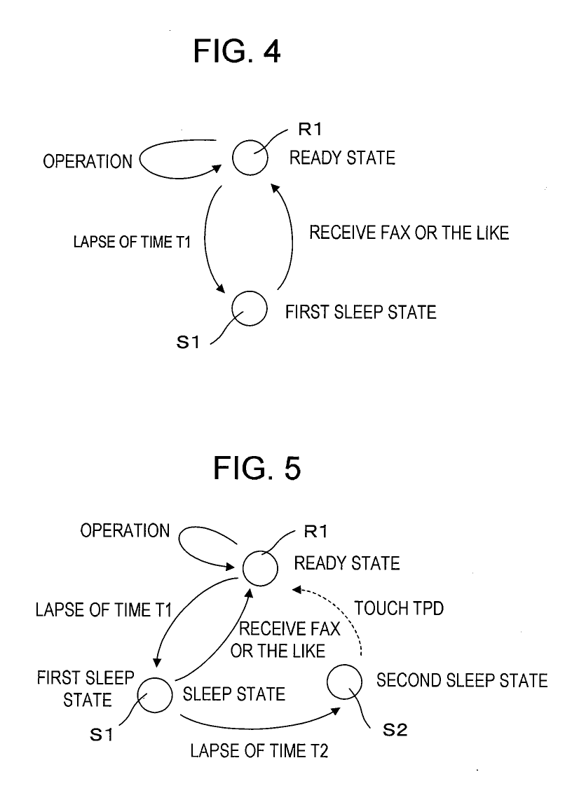

FIG. 4 shows changes in the state of power supply where the network addition device 14 is connected. FIG. 5 shows changes in the state of power supply where the network addition device 14 is not connected. The addition detecting unit 26 detects the network addition device 14. The power supply control unit 28 controls power supply to the network addition device 14.

In the ready state R1, power is supplied to all the units shown in FIG. 2 and all the units are able to operate. In the sleep state S1, the document scanning unit 22 is not supplied with power and therefore unable to operate, whereas the other units are supplied with power and able to operate. Meanwhile, in the second sleep state S2, the document scanning unit 22 and other units are not supplied with power, except the main control unit 27, the power supply control unit 28 and the operation control unit 25. Therefore, energy consumption can be significantly reduced.

Whether the apparatus is in the first sleep state S1 or the second sleet state S2, if a touch panel display TPD (will be described later) on the control panel CP of the operation control unit 25 is touched, the MFP 12 resumes operation and shifts to the ready state R1.

The power supply control unit 28 has an internal timer. Every time the MFP operates, the timer is reset and then starts measuring time again. Where the network addition device 14 is connected, if a first time T1 elapses without the MFP 12 operating, the MFP 12 is shifted to the first sleep state S1, as shown in FIG. 4. When the MFP 12 is operated within the time T1 in order to perform copying or the like, the MFP 12 returns to the ready state R1 again and carries out a designated operation, and then measurement of time is restarted. When there is reception of facsimile data or the like, the MFP 12 returns to the ready state R1 from the first sleep state S1. In this manner, where the network addition device 14 is connected, the MFP 12 does not shift to the second sleep state S2 in which operation of most units is stopped.

Meanwhile, where the network addition device 14 is not connected, the state shifts as shown in FIG. 5. When the time T1 elapses without each unit operating from the ready state R1 in which the MFP is able to operate, the MFP 12 shifts to the first sleep state S1. When there is reception of facsimile data or the like in this state, the MFP 12 returns to the ready state R1. This point is similar to the case where the network addition device 14 is connected.

When a time T2 elapses constantly under a predetermined condition, that is, without any unit of the MFP 12 operating after the shift to the first sleep state S1, the MFP 12 shifts to the second sleep state S2 in which the degree of power saving is higher. To return the MFP 12 to the ready state R1 from this state S2, power supply may be turned off and then turned on again, or the touch panel display TPD on the control panel CP of the operation control unit 25 can be touched.

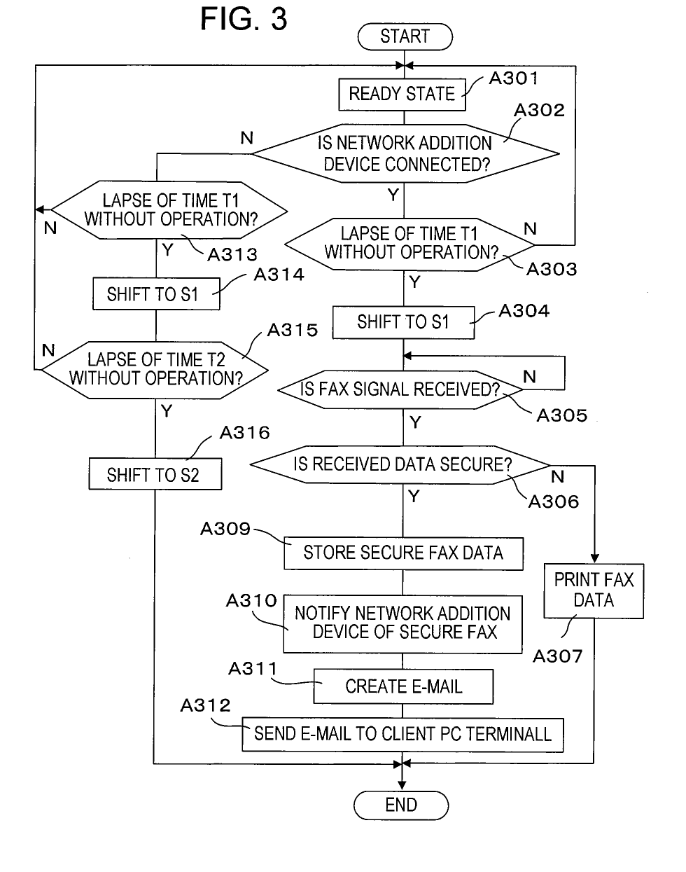

Next, a system in this embodiment will be described mainly based on operation of the MFP with reference to the flowchart of FIG. 3. As operation is started, the MFP 12 enters the ready state in ACT A301. Next, in ACT A302, the addition detecting unit 26 of the MFP 12 shown in FIG. 2 detects whether the network addition device 14 is connected or not. When the network addition device 14 is connected to the MFP 12, the processing shifts to ACT A303 and time measurement is started by the timer provided within the power supply control unit 28. When use of each unit such as the document scanning unit 22 of the MFP 12 is designated from the control panel CP of the operation control unit 25 or the like, the processing returns to ACT A301 and the designated operation is performed. After that, the processing shifts from ACT A302 to ACT A303 and the timer starts measuring time again.

When the predetermined time T1 elapses without using any part of the MFP (A303, Y), the MFP 12 in ACT A304 shifts to the sleep state S1 as shown in FIG. 4. In this state, the document scanning unit 22 is not supplied with power and therefore cannot carry out copying of a document or the like.

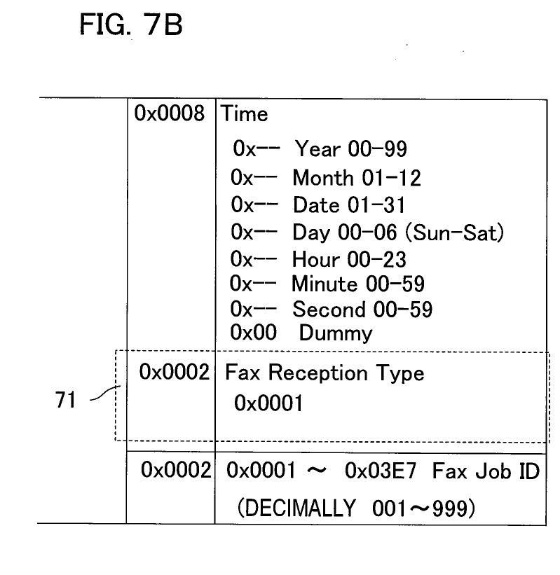

However, the other parts are operating. For example, if a fax is received in ACT A305, the fax transmitting and receiving unit 20 receives this fax. In ACT A306, the fax data detection and storage unit 21 detects whether the fax data is secure data to be treated as secure or ordinary fax data. FIG. 7A and FIG. 7B show an example of fax data received by the fax transmitting and receiving unit 20. As shown in FIG. 7A, command, overall data length and data length are shown. In a dotted-line frame 71 in FIG. 7B, whether the fax data is ordinary fax data or securely received fax data (secure fax data) is displayed in a form of Fax Reception Type data. In a case of this example, the fax reception type is 0x0001, indicating that the fax data is secure fax data. The fax reception type of 0x0000 means that the fax data is ordinary fax data.

When the fax data is ordinary fax data (A306, N), the data is printed by the printing unit 24 in ACT A307.

Meanwhile, if it is detected by the fax data detection and storage unit 21 that the fax data received by the fax transmitting and receiving unit 20 is secure fax data (A306, Y), the data is stored in ACT A309. The fax job ID is incremented by 1 on the same day every time reception occurs. Therefore, secure fax data is specified by its reception date and the fax job ID.

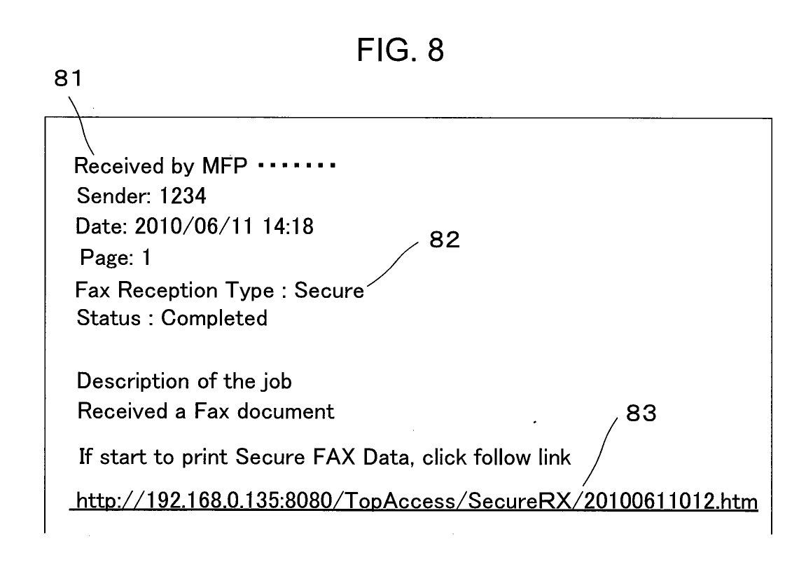

Next, in ACT A310, the fax data detection and storage unit 21 notifies the network addition device 14 that secure fax data is received. Receiving this notification, the e-mail notification unit 29 of the network addition device 14 creates an e-mail to be sent to the destination of the secure fax data. An example of the content of this e-mail to be sent is shown in FIG. 8.

A character string 81 shows that the data is received by the MFP, followed by a sender and date. A character string 82 shows that the fax data type is “secure”.

A character string 83 shows the link of top access provided within the network addition device 14. In the case of this example, the fax job ID is 012, indicating that the secure fax data received twelfth on Jun. 11, 2010.

The e-mail created in this manner in ACT A311 is sent to the client PC terminal 13 in ACT A312.

Meanwhile, if it is detected by the addition detecting unit 26 in ACT A302 that the network addition device 14 is not connected to the MFP 12 (A302, N), the processing shifts to ACT A313 and whether the time during which the MFP 12 does not operate reaches T1 or not. If the MFP 12 operates during this period, the processing returns to ACT A301 and the MFP 12 shifts to the ready state and then performs the designated operation.

When the time T1 elapses without the MFP 12 operating in ACT A313, the processing shifts to ACT A314 and the MFP 12 shifts to the first sleep state S1 shown in FIG. 5. When the time T2 further elapses without the MFP 12 operating (ACT A315), the processing shifts to ACT A316 and the MFP 12 shifts to the second sleep state (S2) shown in FIG. 5. If the MFP 12 operates during this period, the processing returns to ACT A301 and the MFP 12 shifts to the ready state. As the MFP 12 shifts to the second sleep state S2, the document scanning unit 22 of the MFP 12 is not supplied with power and stops its functions, thus saving power.

<Case where a Print Instruction is Given from the Client PC Terminal 13>

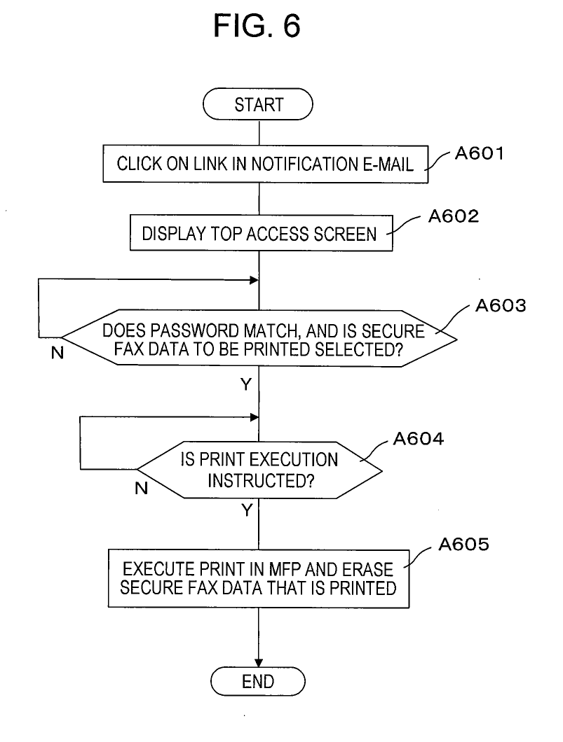

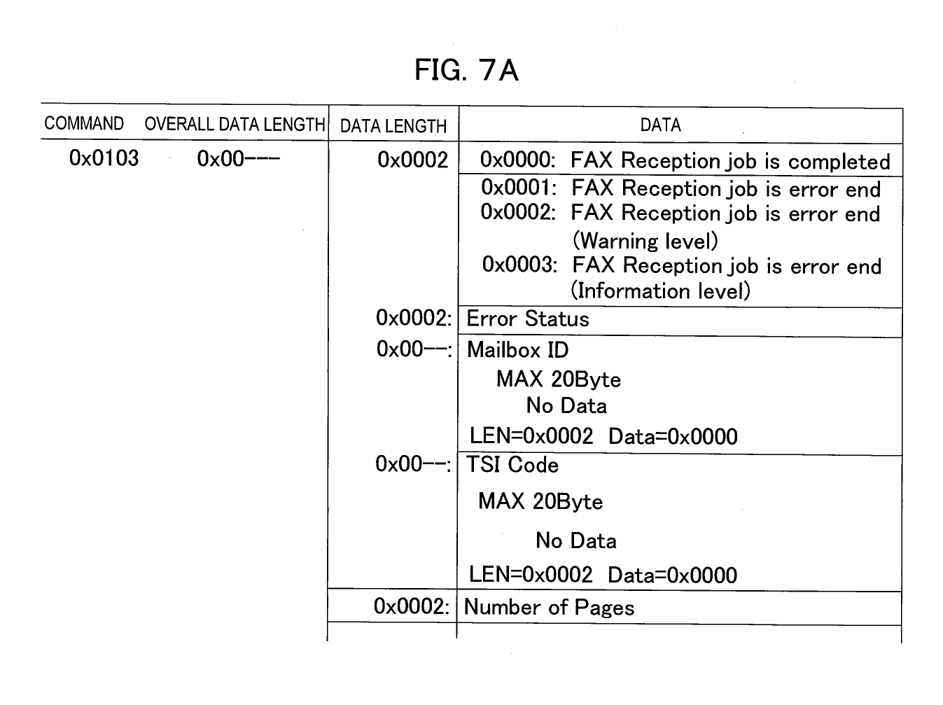

Next, operation in the case where the client PC terminal 13 receives an e-mail sent from the e-mail notification unit 29 as described above will be described with reference to the flowchart of FIG. 6.

When the notification e-mail as shown in FIG. 8 is received by the client PC terminal 13, the user clicks on the link of top access shown by the character string 83 of FIG. 8, in ACT A601 of FIG. 6.

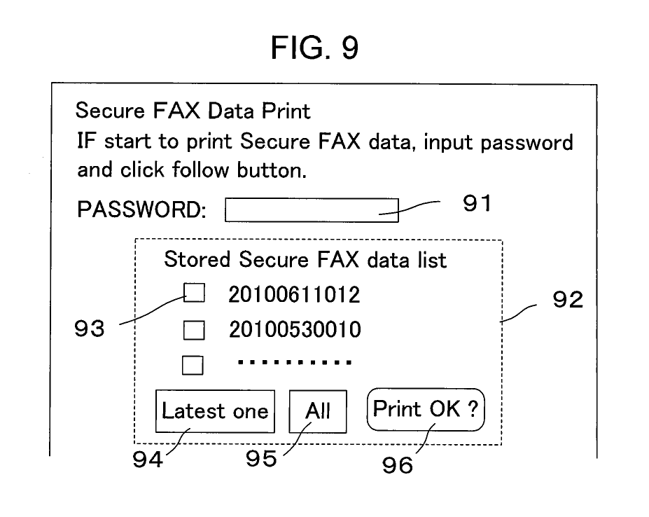

Then, in ACT A602, a top screen of top access shown as an example in FIG. 9 is displayed. A part indicated by a dotted line frame 92 is not displayed yet. In this screen, the user is prompted to enter a password in a blank section 91. When the password that is entered does not match a password that is stored in advance, mismatch of the password is displayed and the user is prompted to enter a password again.

When the password that is entered matches the password that is stored in advance, the part indicated by the dotted line frame 92 in FIG. 9 is displayed. By this display, a list of secure fax data stored in the fax data detection and storage unit 21 is displayed. The user can check a frame section displayed beside each data using a mouse, or click on display icons 94 and 95 provided below, using a mouse. The display icon 94 indicates that the latest secure fax data is to be printed. The display icon 95 indicates that all the remaining secure fax data are to be printed.

When a print execution icon 96 is clicked on after the secure fax data to be printed is selected, a control signal for print instruction is sent to the fax data detection and storage unit 21 of the MFP 12 from the top access screen. In ACT A605, the selected secure fax data is printed by the printing unit 24 and outputted from the MFP 12. Simultaneously, the secure fax data that is printed is deleted.

In this manner, an instruction to print secure fax data can be given to the MFP 12 from the client PC terminal 13 connected to the network.

In this embodiment, a password is entered if giving a print instruction from the client PC terminal. However, entry of a password is not necessarily required in cases where the terminal user is limited and so on.

In this embodiment, the top access screen is generated in the network addition device in order to give a print instruction from the client PC terminal. However, a screen such as top access need not necessarily be generated if secure fax data stored in the MFP can be specified from the network addition device.

<Case where a Print Instruction is Given from the Control Panel CP>

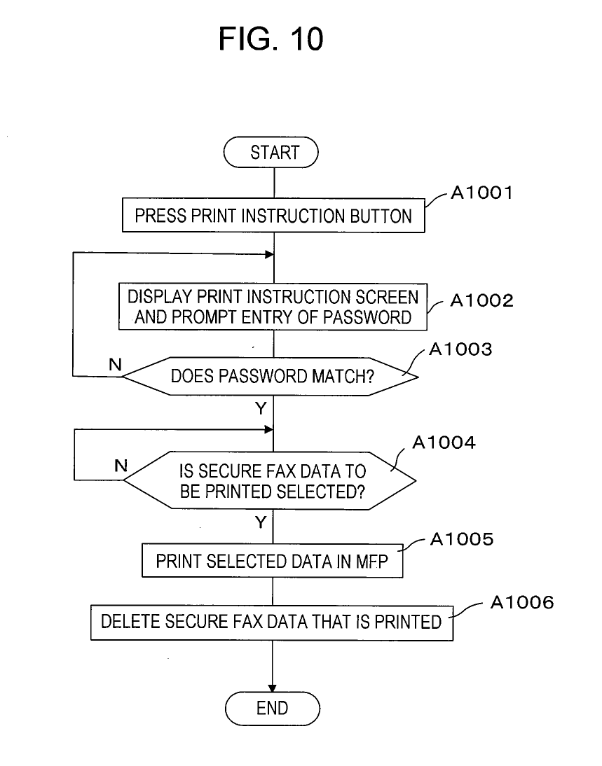

Next, an example of giving an instruction to print secure fax data from the control panel CP of the MFP 12 will be described with reference to the flowchart shown in FIG. 10.

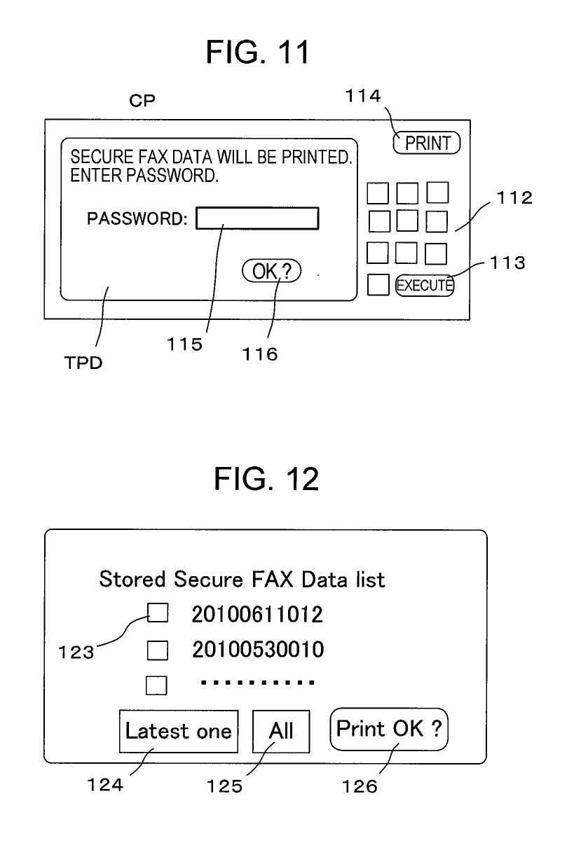

An exemplary configuration of the control panel is shown in FIG. 11. The touch panel display TPD is located on the left side in the control panel CP. Ten keys 112 are located on the bottom right side (forward side). An execution key 113 is provided at the bottom right corner. At the top right corner of the control panel CP, a print instruction button 114 is provided which is pressed if printing secure fax data.

As this print instruction button 114 is pressed, the operation control unit 25 shows a display as shown in FIG. 11, in the touch panel display TPD in ACT A1002. The user enters a password in a password section 115, for example, via the ten keys 112 and then touches a completion icon 116.

Thus, in ACT A1003, the operation control unit 25 checks whether the entered password that is entered matches a stored password that is stored in advance. When both passwords match, for example, a display as shown in FIG. 12 is shown in the touch panel display TPD. This display shows a list of secure fax data stored in the fax data detection and storage unit 21, similarly to the display within the dotted line frame 92 of FIG. 9. A square 123 is shown beside each of the stored secure fax data. A display icon 124 for selecting the latest secure fax data and a display icon 125 for selecting all the secure fax data are displayed. After selecting these secure fax data, the user clicks on a print execution icon 126.

As the print execution icon 126 is clicked on (ACT A1004, Y) after the secure fax data to be printed is selected, a control signal for print instruction is sent to the fax data detection and storage unit 21 of the MFP 12 from the operation control unit 25. In ACT A1005, the selected secure fax data is printed by the printing unit 24 and outputted from the MFP 12.

Next, in ACT A1006, the operation control unit 25 deletes the secure fax data that is printed from the fax data detection and storage unit 21 and completes the series of the print job of secure fax data.

Thus, an instruction to print secure fax data can also be given from the control panel CP of the MFP 12.

### <Modifications>

In the embodiment, the case of giving a print instruction from the touch panel display TPD of the control panel CP is described. However, secure fax data that is stored may be displayed with numbers on the panel display without using the touch panel display TPD, and secure fax data may be designated via the ten keys. The latest secure fax data to be printed or the like can also be designated from the control panel or other units without using such panel display.

In the embodiment, the case of having the fax transmitting and receiving unit capable of transmitting and receiving facsimile data is described. However, it suffices to have at least a fax receiving unit capable of receiving facsimile signals.

In the embodiment, as an MFP, the image forming apparatus is described which forms a latent image by selective exposure and attaching toner to visualize the latent image if carrying out copy or the like. However, the technique can also be applied to an image forming apparatus which forms a visualized image using other systems, for example, an ink jet system. The technique can also be applied to a fax receiver which only prints fax-received data without copying or the like. The image forming apparatus according to embodiments include such apparatuses.

In the embodiment, the case of stopping power supply to the document scanning unit of the MFP in the first sleep state is described. However, power supply to other parts can also be stopped. As long as the fax data detection and storage unit 21 and the printing unit 24 can be started up so that secure fax data can be printed if a print instruction is given from the client PC terminal 13 or the control panel CP, power supply to these units and the fax transmitting and receiving unit 20 and the like can be stopped in the first sleep state.

In the embodiment, the case of having two sleep states where a part of power supply is stopped is described. However, there may be only one sleep state or may be three or more sleep states. It suffices to enable at least printing of secure fax data if a print instruction is given from the client PC terminal 13 or the control panel CP.

In the embodiment, the case where a print instruction can be given from the client PC terminal and the control panel CP is described. However, printing only from the client PC terminal is also possible.

In the embodiment, the case of giving a print instruction from the client terminal made up of a personal computer is described. However, the client terminal need not be a personal computer and simply can be a client terminal. Of course, the client terminal may be a general purpose personal computer for ordinary use.

According to the embodiments, an instruction to print secure fax data can be given from a client terminal that is away from an MFP having a print function and having secure fax data stored therein.

According to the embodiments, the network addition device can be attached to and detached from the MFP. When the network addition device is connected and an external terminal accesses the device to give an instruction to print fax data, the data can be printed. When the network addition device is not connected, the number of units in the MFP whose power supply can be stopped can be increased and power consumption can be reduced further.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a fax receiving unit capable of receiving facsimile data;
a printing unit which prints the facsimile data received by the fax receiving unit;
a fax data storage unit in which, if the facsimile data received by the fax receiving unit is secure fax data, this secure fax data is stored; and
an addition detecting unit which detects that a removable network addition device is connected to the apparatus.

2. The apparatus of claim 1, wherein the printing unit prints the secure fax data stored in the fax data storage unit if an instruction to print the secure fax data is given from a client terminal connected to a network.

3. The apparatus of claim 2, wherein a notification that the secure fax data is received, sent to the client terminal, is via an e-mail.

4. The apparatus of claim 3, wherein the e-mail is created in the network addition device.

5. The apparatus of claim 4, wherein an address that enables the network addition device to specify a place of the secure fax data stored in the apparatus is shown in the e-mail.

6. The apparatus of claim 2, further comprising a power supply control unit which can stop power supply to each unit if the apparatus does not operate for a predetermined time,
wherein if the addition detecting unit does not detect that the network addition device is connected, the stop of power supply to the each unit in the case of non-operation for the predetermined time is made greater than if the addition detecting unit detects that the network addition device is connected.

7. The apparatus of claim 6, wherein if the addition detecting unit detects that the network addition device is connected and the instruction to print the secure fax data is given from the client terminal, the power supply control unit can supply power to the fax data storage unit and the printing unit.

8. The apparatus of claim 7, further comprising a control panel from which the instruction to print the secure fax data stored in the fax data storage unit can be given.

9. An image forming apparatus comprising:
a fax receiving unit capable of receiving facsimile data;
a fax data storage unit in which, if the facsimile data received by the fax receiving unit is secure fax data, this secure fax data is stored;
an addition detecting unit which detects that a removable network addition device is connected to the apparatus; and
a printing unit which prints the secure fax data stored in the fax data storage unit if an instruction to print the secure fax data is given from a client terminal connected to a network.

10. The apparatus of claim 9, further comprising a main control unit which controls the fax receiving unit, the fax data storage unit, the addition detecting unit and the printing unit.

11. The apparatus of claim 10, further comprising a control panel from which the instruction to print the secure fax data stored in the fax data storage unit can be given.

12. The apparatus of claim 11, further comprising a power supply control unit which can stop power supply to each unit, and comprising a first sleep state where power supply to a part of the units is stopped if the apparatus does not operate for a first predetermined time, and a second sleep state where power supply to a greater number of the units is stopped than in the first sleep state if the apparatus does not operate for a second predetermined time following the first sleep state,
wherein if the addition detecting unit detects that the network addition device is connected, the apparatus does not shift to the second sleep state, to which the apparatus shifts if the network addition device is not connected.

13. The apparatus of claim 12, wherein if the addition detecting unit detects that the network addition device is connected, the apparatus shifts to the first sleep state if the apparatus does not operate for the first predetermined time, but does not shift to the second sleep state even if the apparatus does not operate for the second predetermined time after that.

14. An image forming apparatus comprising:
a fax receiving unit capable of receiving facsimile data;
a printing unit which prints the facsimile data received by the fax receiving unit;
a fax data detecting unit which detects whether the facsimile data received by the fax receiving unit is secure fax data or ordinary fax data;
a fax data storage unit in which, if the fax data detecting unit detects that the facsimile data received by the fax receiving unit is secure fax data, this secure fax data is stored; and
an addition detecting unit which detects that a removable network addition device is connected to the apparatus.

15. The apparatus of claim 14, wherein a notification that the secure fax data is received, sent to a client terminal, is via an e-mail.

16. The apparatus of claim 15, wherein the e-mail is created in the network addition device which is attachable to and detachable from the apparatus.

17. The apparatus of claim 16, wherein an address that enables the network addition device to specify a place of the secure fax data stored in the apparatus is shown in the e-mail.

18. A data notification and printing method by an image forming apparatus, comprising:
receiving facsimile data in the apparatus;
detecting whether the received facsimile data is secure fax data or not;
if the facsimile data is secure fax data, storing the secure fax data in the apparatus; and
notifying a client terminal connected to a network, via a removable network addition device connected to the apparatus.

19. The method of claim 18, wherein if an instruction to print the secure fax data is given from the client terminal, the data is printed by the apparatus.

20. The method of claim 19, wherein a notification that the secure fax data is received, sent to the network addition device from the apparatus, is via an e-mail.
